(19) United States
(12) Patent Application Publication
(10) Pub. No.: US 2024/0257996 A1
(43) Pub. Date: Aug. 1, 2024

(54) SYSTEM AND METHOD OF MAKING AN ELECTRIC CONDUCTOR HAVING A CONDUCTIVE SKIN LAYER

(71) Applicant: GM Global Technology Operations LLC, Detroit, MI (US)

(72) Inventors: Qigui Wang, Rochester Hills, MI (US); John S. Agapiou, Rochester Hills, MI (US); Liang Wang, Rochester Hills, MI (US); Lei Hao, Troy, MI (US)

(21) Appl. No.: 18/161,496

(22) Filed: Jan. 30, 2023

(51) Int. Cl. H01B 13/00; B23K 20/02; H01B 5/02

(52) U.S. Cl. CPC H01B 13/0036; B23K 20/023; H01B 5/02; H01B 13/0016; B23K 2101/38; B23K 2103/10

(57) ABSTRACT

A method of making an electric conductor having a conductive skin layer. The method comprises providing a conductive member having a first width and a conductive layer disposed thereon for conductivity. The conductive layer has a second width to define a width ratio of the first width to the second width of 4:1 to 200:1. The conductive layer has greater conductivity than the conductive member. The method comprises disposing the conductive layer about the conductive member to define a conductive layered member and pressing the conductive layered member for mechanical contact to define a pressed layered member. The method comprises thermally treating the pressed layered member for diffusion between the conductive layer and the conductive member defining a diffused layered member. The method further comprises cooling the diffused layered member for diffusion bonding free of an intermetallic phase between the conductive layer and the conductive member.

### GOVERNMENT FUNDING

This invention was made with government support under contract No. DE-FOA-0002611 awarded by the U.S. Department of Energy. The government has certain rights in the invention.

### INTRODUCTION

The present disclosure relates to electric conductors and, more particularly, systems and methods of making electric conductors having conductive skin layers.

With increasing demand of fuel efficiency and particularly reduction of greenhouse gas emissions, today's automotive industry has begun a new era of manufacturing environmentally friendly zero-emission vehicles such as battery electric vehicles. Current challenges are met by increasing motor power density, speed, and torque capability.

### SUMMARY

Thus, while current electric conductors and wires achieve their intended purpose, there is a need for a new and improved system and method of making an electric conductor having a conductive skin layer to compensate for the skin effect and reduce the effective winding resistance.

In accordance with one aspect of the present disclosure, a method of making an electric conductor having a conductive skin layer is provided. The method comprises providing a conductive member having a first width and a conductive layer having carbon nanotubes disposed thereon in a predetermined orientation for conductivity. The conductive layer has a second width to define a width ratio of the first width to the second width of between 4:1 and 200:1. Moreover, the conductive layer has greater conductivity than the conductive member.

The method further comprises disposing the conductive layer about the conductive member to define a conductive layered member having a cross-sectional geometry. The method further comprises pressing the conductive layered member for mechanical contact between the conductive layer and the conductive member such that the cross-sectional geometry has less than 5% deformation reduction to define a pressed layered member.

The method further comprises thermally treating the pressed layered member at a predetermined temperature and a predetermined pressure for at least 30 minutes for diffusion between the conductive layer and the conductive member defining a diffused layered member. The method further comprises cooling the diffused layered member for diffusion bonding free of an intermetallic phase between the conductive layer and the conductive member.

In one example of this aspect, the first width is between 0.1 millimeter (mm) and 5 mm. In another example, the first width is between 1 mm and 3 mm. In yet another example, the second width is between 0.015 mm and 0.035 mm. In still another example, the width ratio is between 40:1 and 120:1.

In one example, the conductive member comprises copper. Moreover, the predetermined temperature is between 800 degrees Celsius (C) and 900° C. and the predetermined pressure is 100 megapascal (MPa) and 120 MPa. In another example, the conductive member comprises aluminum. Moreover, the predetermined temperature is between 150° C. and 250° C. and the predetermined pressure is 20 MPa and 30 MPa. In yet another example, each of the carbon nanotubes is between 80 microns and 120 microns and wherein the predetermined orientation is along a longitudinal axis of the conductive member.

In accordance with another aspect of the present disclosure, a system for making an electric conductor having a conductive skin layer is provided. The system comprises a conductive member having a first width and a conductive layer having carbon nanotubes disposed thereon in a predetermined orientation for conductivity. Moreover, the conductive layer has a second width to define a width ratio of the first width to the second width of between 4:1 and 200:1. In addition, the conductive layer has a greater conductivity than the conductive member.

In this aspect, the system further comprises a depositing unit arranged to dispose the conductive layer about the conductive member to define a conductive layered member having a cross-sectional geometry.

The system further comprises a pressing unit arranged to press the conductive layered member for mechanical contact between the conductive layer and the conductive member such that the cross-sectional geometry has less than 5% deformation reduction to define a pressed layered member.

The system further comprises a furnace arranged to thermally treat the pressed layered member at a predetermined temperature and a predetermined pressure for at least 30 minutes for diffusion between the conductive layer and the conductive member defining a diffused layered member.

The system further comprises a cooling unit arranged to cool the diffused layered member for diffusion bonding free of an intermetallic phase between the conductive layer and the conductive member.

The system further comprises a controller in communication with the depositing unit, the pressing unit, the furnace and the cooling unit. Moreover, the controller is arranged to control the depositing unit, the pressing unit, the furnace, and the cooling unit. The system further comprises a power source arranged to power the depositing unit, the pressing unit, the furnace, the cooling unit, and the controller.

In one embodiment, the first width is between 0.1 millimeter (mm) and 5 mm. In another embodiment, the first width is between 1 mm and 3 mm. In yet another embodiment, the second width is between 0.015 mm and 0.035 mm. In still another embodiment, the width ratio is between 40:1 and 120:1.

In an embodiment, the conductive member comprises copper. Moreover, the predetermined temperature is between 800 degrees Celsius (C) and 900° C. and the predetermined pressure is 100 megapascal (MPa) and 120 MPa.

In another embodiment, the conductive member comprises aluminum. Moreover, the predetermined temperature is between 150° C. and 250° C. and the predetermined pressure is 20 MPa and 30 MPa. In yet another embodiment, each of the carbon nanotubes is between 80 microns and 120 microns and wherein the predetermined orientation is along a longitudinal axis of the conductive member.

In accordance with yet another aspect of the present disclosure, an electric conductor for a motor of a vehicle. The electric conductor has a conductive skin layer. The electric conductor comprises a conductive member having a first width and a conductive layer diffusion bonded about the conductive member free of an intermetallic phase between the conductive layer and the conductive member. Moreover, the conductive layer has carbon nanotubes disposed thereon at a predetermined orientation for conductivity. Additionally, the conductive layer has a second width to define a width ratio of the first width to the second width of between 4:1 and 200:1. Furthermore, the conductive layer has greater conductivity than the conductive member.

In one embodiment, the first width is between 1 mm and 3 mm. In another embodiment, the second width is between 0.015 mm and 0.035 mm. In yet another embodiment, the width ratio is between 40:1 and 120:1.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a system for making an electric conductor having a conductive skin layer in accordance with one embodiment of the present disclosure.

FIG. 2 is a partial cross-sectional side view of a conductive layered member of the system in FIG. 1.

FIG. 3A is cross-sectional end view of the conductive layered member in FIG. 2 taken along lines 3-3.

FIG. 3B is a cross-sectional end view of a conductive layered member in accordance with another embodiment of the present disclosure.

FIG. 4 is a partial cross-sectional side view of the electric conductor of the system in FIG. 1.

FIG. 5 is an enlarged conceptual view of circle 5 in FIG. 4.

FIG. 6 is a flowchart of a method of making an electric conductor having a conductive skin layer in accordance with one example of the present disclosure.

### DETAILED DESCRIPTION

The following description is merely exemplary in nature and is not intended to limit the present disclosure, application, or uses.

Embodiments and examples of the present disclosure provide systems and methods of making an electric conductor having a conductive skin layer. An electric conductor of the present disclosure may be used as an electrical connector (e.g., wire, bar, cable) in electric vehicles. Such electric conductor helps to compensate resistance observed at AC frequencies above 1000 Hertz. As a result, the electric conductors of the present disclosure help decrease loss in motor power density, speed, and torque capability.

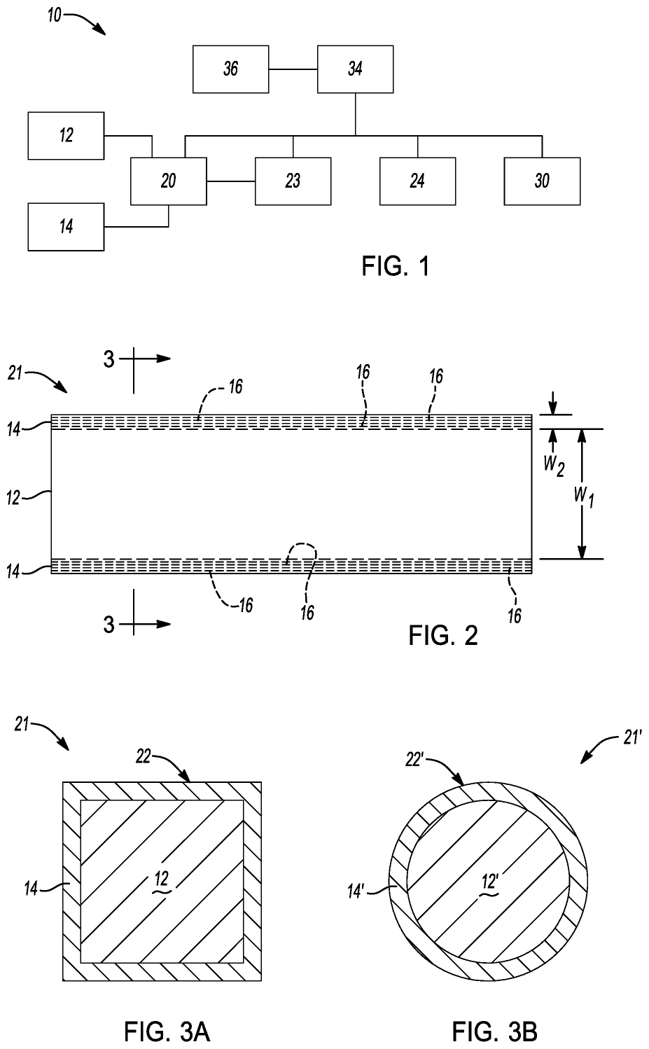

FIG. 1 illustrates a system 10 for making an electric conductor having a conductive skin layer in accordance with one embodiment of the present disclosure. As shown in FIGS. 1-2, the system 10 comprises a conductive member 12 defining a longitudinal axis X and having a first width W₁ and a first conductivity. The conductive member 12 may be an electrically conductive wire, bar, cable, or any other conductive item without departing from the spirit or scope of the present disclosure. Moreover, the conductive member 12 comprises one of copper and aluminum. Preferably, the first width W₁ is between 0.1 millimeter (mm) and 5 mm and, more preferably, between 1 mm and 3 mm.

The system further comprises a conductive layer 14 having a second width W₂ and a second conductivity. Preferably, the second width W₂ is between 0.015 mm and 0.035 mm and, more preferably, 0.025 mm. Moreover, the first and second widths W₁, W₂ define a width ratio of the first width to the second width preferably between 4:1 and 200:1. In another embodiment, the width ratio is more preferably between 40:1 and 120:1. Furthermore, the conductive layer 14 has a greater conductivity than the conductive member 12.

In this embodiment, the conductive layer 14 comprises carbon nanotubes 16 disposed thereon in a predetermined orientation for enhanced conductivity. As shown in FIG. 3A, the carbon nanotubes 16 are disposed on the conductive layer 14 in a direction along the longitudinal axis X of the conductive member 12. In this embodiment, each of the carbon nanotubes 16 is preferably between 80 microns and 120 microns and, more preferably 100 microns. In one embodiment, the conductive layer may be an ultra-conductive composite being a tape/film material comprised of copper and coated with aligned carbon nanotubes.

As shown in FIG. 1, the system 10 further comprises a depositing unit/area 20 arranged to dispose the conductive layer 14 about the conductive member 12 to define a conductive layered member 21 (see FIG. 2). Referring to FIGS. 2 and 3, the conductive layered member 21 has a cross-sectional geometry 22. The depositing unit 20 may comprise any robotic mechanism for disposing the conductive layer 14 about the conductive member 12. It is to be understood that any suitable mechanism for disposing the conductive layer 14 about the conductive member 12 may be used without departing from the spirit or scope of the present disclosure.

Referring to FIG. 1, the system 10 further comprises a pressing unit 23 arranged to press the conductive layered member 21 for mechanical contact between the conductive layer 14 and the conductive member 12. In this embodiment, the conductive layer 14 is pressed on the conductive member 12 such that the cross-sectional geometry 22 (see FIG. 3A) has less than 5% deformation reduction to define a pressed layered member. In one embodiment, the pressing unit 23 may comprise a plurality of rollers that receives the conductive layered member 21 and applies pressure to provide mechanical contact between the conductive layer 14 and the conductive member 12 with less than 5% deformation reduction to the cross-sectional geometry 22 thereof. It is to be understood that any other suitable pressing mechanism may be used to provide mechanical contact without departing from the spirit or scope of the present disclosure.

The shape or geometry 22 in FIG. 3A is shown to be rectangular but can take any shape or geometry such as circular, oval, or any other suitable shape without departing from the spirit or scope of the present disclosure. For example and as shown in FIG. 3B, geometry 22′ is circular and conductive member 12′ is a solid conductive cylindrical member. Conductive layer 14′ is wrapped/folded around the cylindrical conductive member 12′ and then pressed in pressing unit 23 using a drawing die to form cylindrical member 21′.

As depicted in FIG. 1, the system 10 further comprises a furnace 24 arranged to thermally treat the pressed layered member. The furnace 24 may be operated at a predetermined temperature and a predetermined pressure. At the predetermined temperature and the predetermined pressure for at least 30 minutes, the pressed layered member is thermally treated in the furnace for diffusion between the conductive layer 14 and the conductive member 12 defining a diffused layered member. Furthermore, the furnace 24 may operate with an atmosphere of air or nitrogen.

In one embodiment wherein the conductive member 12 comprises copper, the predetermined temperature is between 800 degrees Celsius (C) and 900° C. and the predetermined pressure is 100 megapascal (MPa) and 120 MPa. In another embodiment wherein the conductive member 12 comprises aluminum, the predetermined temperature is between 150° C. and 250° C. and the predetermined pressure is 20 MPa and 30 MPa.

Optionally, the system 10 may comprise a HIP unit (not shown) in which the diffused layered member is processed. As known, HIP or hot isostatic pressing (HIPing) is a simultaneous application of controlled heat and high pressure to an item (here, the diffused layered member) using specialized chambers. The HIP unit is arranged to reduce internal porosity of the diffused layered member by way of the predetermined temperature and the predetermined pressure. In an embodiment wherein the conductive member comprises copper, the predetermined temperature is between 800 degrees Celsius (C) and 900° C. and the predetermined pressure is 100 megapascal (MPa) and 120 MPa for at least 30 minutes. In an embodiment wherein the conductive member comprises aluminum, the predetermined temperature is between 150° C. and 250° C. and the predetermined pressure is 20 MPa and 30 MPa for at least 30 minutes. Furthermore, the HIP unit may operate with an atmosphere of air or nitrogen.

Referring to FIGS. 1, 4, and 5, the system 10 further comprises a cooling unit 30 arranged to cool the diffused layered member defining a diffusion-bonded member or the electric conductor 32. That is, the cooling unit cools the diffused layered member such that diffusion bonding occurs between the conductive member and the conductive layer. Additionally, as seen in FIG. 5, the diffusion-bonded member 32 is free of an intermetallic phase between the conductive layer 14 and the conductive member 12. The cooling unit may be any suitable mechanism to cool the diffused layered member such as a cooling bin, a cooling area, a cooling bath using air, nitrogen or any suitable cooling fluid without departing from the scope or spirit of the present disclosure.

As known, diffusion bonding operates on the principle of solid-state diffusion wherein atoms of a first solid metallic surface intersperse with a second solid metallic surface over thermal treatment, pressure, and time. The surfaces are then cooled to form diffusion bonding. Here, atoms of the conductive member 12 intersperse with atoms of the conductive layer 14 (and vice-versa) in the furnace 24 (or HIP unit) and diffusion bond during cooling. As shown in FIG. 5, the diffusion bonding between the conductive member 12 and conductive layer 14 occurs free of an intermetallic phase between the conductive layer and the conductive member. That is, the diffusion bonding between the conductive member 12 and the conductive layer 12 is free of any residual formations therebetween that compromise the integrity of the bond.

Illustrated in FIG. 1, the system 10 further comprises a controller 34 in communication with the depositing unit 20, the pressing unit 23, the furnace 24, and the cooling unit 30. Moreover, the controller 34 is arranged to control the depositing unit 20, the pressing unit 23, the furnace 24, and the cooling unit 30. It is to be understood that each unit of the system may comprise a separate controller without departing from the spirit or scope of the present disclosure. Furthermore, the system 10 further comprises a power source 36 arranged to power the depositing unit 20, the pressing unit 23, the furnace 24, the cooling unit 30, and the controller 34.

FIG. 6 illustrates a method 110 of making an electric conductor having a conductive skin layer in accordance with one example of the present disclosure. In this example, the method 110 is implemented by the system 10 of FIG. 1. As shown, the method 110 comprises in box 112 providing a conductive member 12 and a conductive layer 14. The conductive member 12 define a longitudinal axis X and has a first width W₁ and a first conductivity. In this example, the conductive member 12 comprises one of copper and aluminum. Preferably, the first width W₁ is between 0.1 millimeter (mm) and 5 mm and, more preferably, between 1 mm and 3 mm.

The conductive layer 14 has a second width W₂ and a second conductivity. Preferably, the second width W₂ is between 0.015 mm and 0.035 mm and, more preferably, 0.025 mm. Moreover, the first and second widths W₁, W₂ define a width ratio of the first width W₁ to the second width W₂ preferably between 4:1 and 200:1. In another embodiment, the width ratio is more preferably between 40:1 and 120:1. Furthermore, the conductive layer 14 has a greater conductivity than the conductive member 12.

In this embodiment, the conductive layer 14 comprises carbon nanotubes 16 disposed thereon in a predetermined orientation for enhanced conductivity. As shown in FIG. 3A, the carbon nanotubes 16 are disposed on the conductive layer 14 in a direction along the longitudinal axis X of the conductive member 12. In this embodiment, each of the carbon nanotubes 16 is preferably between 80 microns and 120 microns and, more preferably 100 microns.

Referring to FIG. 6, the method 110 further comprises in box 114 disposing the conductive layer 14 about the conductive member 12 to define a conductive layered member 21 having a cross-sectional geometry 22. In this example, the depositing unit 20 of the system discussed above may be implemented to dispose the conductive layer 14 about the conductive member 12 to define a conductive layered member. Referring to FIGS. 2 and 3, the conductive layered member 21 has a cross-sectional geometry 22. The depositing unit 20 may comprise any robotic mechanism for disposing the conductive layer 14 about the conductive member 12. It is to be understood that any suitable mechanism for disposing the conductive layer 14 about the conductive member 12 may be used without departing from the spirit or scope of the present disclosure.

The method 110 further comprises in box 116 pressing the conductive layered member 21 for mechanical contact between the conductive layer 14 and the conductive member 14 such that the cross-sectional geometry 22 has less than 5% deformation reduction to define a pressed layered member. In this example, the pressing unit 23 of the system 10 above may be implemented to press the conductive layered member 21 for mechanical contact between the conductive layer 14 and the conductive member 12. In this example, the conductive layer 14 is pressed on the conductive member 12 such that the cross-sectional geometry 22 (see FIG. 3A) has less than 5% deformation reduction to define the pressed layered member. In one example, the pressing unit 23 may comprise a plurality of rollers that receives the conductive layered member 21 and applies pressure to provide mechanical contact between the conductive layer 14 and the conductive member 12 with less than 5% deformation reduction to the cross-sectional geometry 22 thereof. It is to be understood that any other suitable pressing mechanism may be used to provide mechanical contact without departing from the spirit or scope of the present disclosure.

The method 110 further comprises in box 120 thermally treating the pressed layered member at a predetermined temperature and a predetermined pressure for at least 30 minutes for diffusion between the conductive layer 14 and the conductive member 12 defining a diffused layered member. In this example, the furnace 24 and/or the HIP unit of the system 10 above may be implemented to thermally treat the pressed layered member. The furnace 24 may be operated at a predetermined temperature and a predetermined pressure. At the predetermined temperature and the predetermined pressure for at least 30 minutes, the pressed layered member is thermally treated in the furnace for diffusion between the conductive layer 14 and the conductive member 12 defining the diffused layered member. Furthermore, the furnace 24 may operate with an atmosphere of air or nitrogen.

In one example wherein the conductive member 12 comprises copper, the predetermined temperature is between 800 degrees Celsius (C) and 900° C. and the predetermined pressure is 100 megapascal (MPa) and 120 MPa. In another example wherein the conductive member 12 comprises aluminum, the predetermined temperature is between 150° C. and 250° C. and the predetermined pressure is 20 MPa and 30 MPa.

The method 110 further comprises in box 122 cooling the diffused layered member for diffusion bonding free of an intermetallic phase between the conductive layer 14 and the conductive member 12. In this example, the cooling unit 30 of the system 10 above is implemented to cool the diffused layered member defining a diffusion-bonded member or the electric conductor 32. That is, the cooling unit 30 cools the diffused layered member such that diffusion bonding occurs between the conductive member 12 and the conductive layer 14. As mentioned, the diffusion-bonded member 32 is free of an intermetallic phase between the conductive layer 14 and the conductive member 12. The cooling unit 30 may be any suitable mechanism to cool the diffused layered member such as a cooling bin, a cooling area, a cooling bath using air, nitrogen or any suitable cooling fluid without departing from the scope or spirit of the present disclosure.

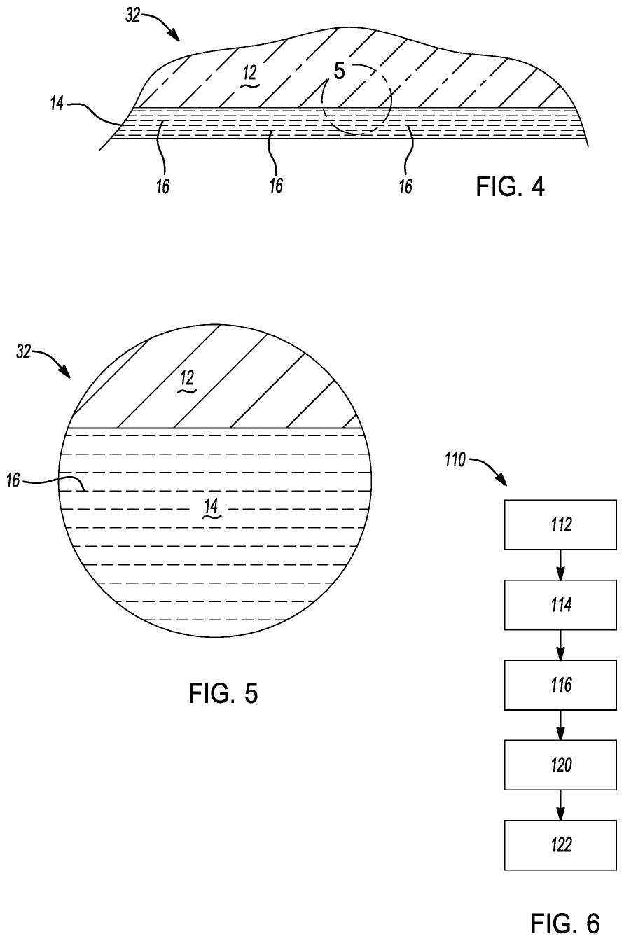

As known, diffusion bonding operates on the principle of solid-state diffusion wherein atoms of a first solid metallic surface intersperse with a second solid metallic surface over thermal treatment, pressure, and time. The surfaces are then cooled to form diffusion bonding. Here, atoms of the conductive member 12 intersperse with atoms of the conductive layer 14 (and vica-versa) in the furnace 24 (or the HIP unit) and diffusion bond during cooling. As shown in FIG. 4-5, the diffusion bonding between the conductive member 12 and conductive layer 14 occurs free of an intermetallic phase therebetween. That is, the diffusion bonding between the conductive member 12 and the conductive layer 14 is free of any residual formations therebetween that compromise the integrity of the bond.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of making an electric conductor having a conductive skin layer, the method comprising:
providing a conductive member having a first width and a conductive layer having carbon nanotubes disposed thereon in a predetermined orientation for conductivity, the conductive layer having a second width to define a width ratio of the first width to the second width of between 4:1 and 200:1, the conductive layer having greater conductivity than the conductive member;
disposing the conductive layer about the conductive member to define a conductive layered member having a cross-sectional geometry;
pressing the conductive layered member for mechanical contact between the conductive layer and the conductive member such that the cross-sectional geometry has less than 5% deformation reduction to define a pressed layered member;
thermally treating the pressed layered member at a predetermined temperature and a predetermined pressure for at least 30 minutes for diffusion between the conductive layer and the conductive member defining a diffused layered member; and
cooling the diffused layered member for diffusion bonding free of an intermetallic phase between the conductive layer and the conductive member.

2. The method of claim 1 wherein the first width is between 0.1 millimeter (mm) and 5 mm.

3. The method of claim 1 wherein the first width is between 1 mm and 3 mm.

4. The method of claim 1 wherein the second width is between 0.015 mm and 0.035 mm.

5. The method of claim 1 wherein the width ratio is between 40:1 and 120:1.

6. The method of claim 1 wherein the conductive member comprises copper, the predetermined temperature is between 800 degrees Celsius (C) and 900° C., and the predetermined pressure is 100 megapascal (MPa) and 120 MPa.

7. The method of claim 1 wherein the conductive member comprises aluminum, the predetermined temperature is between 150° C. and 250° C., and the predetermined pressure is 20 MPa and 30 MPa.

8. The method of claim 1 wherein each of the carbon nanotubes is between 80 microns and 120 microns and wherein the predetermined orientation is along a longitudinal axis of the conductive member.

9. A system for making an electric conductor having a conductive skin layer, the system comprising:
a conductive member having a first width;
a conductive layer having carbon nanotubes disposed thereon in a predetermined orientation for conductivity, the conductive layer having a second width to define a width ratio of the first width to the second width of between 4:1 and 200:1, the conductive layer having greater conductivity than the conductive member;
a depositing unit arranged to dispose the conductive layer about the conductive member to define a conductive layered member having a cross-sectional geometry;
a pressing unit arranged to press the conductive layered member for mechanical contact between the conductive layer and the conductive member such that the cross-sectional geometry has less than 5% deformation reduction to define a pressed layered member;
a furnace arranged to thermally treat the pressed layered member at a predetermined temperature and a predetermined pressure for at least 30 minutes for diffusion between the conductive layer and the conductive member defining a diffused layered member;
a cooling unit arranged to cool the diffused layered member for diffusion bonding free of an intermetallic phase between the conductive layer and the conductive member;
a controller in communication with the depositing unit, the pressing unit, the furnace and the cooling unit, the controller arranged to control the depositing unit, the pressing unit, the furnace, and the cooling unit; and
a power source arranged to power the depositing unit, the pressing unit, the furnace, the cooling unit, and the controller.

10. The system of claim 9 wherein the first width is between 0.1 millimeter (mm) and 5 mm.

11. The system of claim 9 wherein the first width is between 1 mm and 3 mm.

12. The system of claim 9 wherein the second width is between 0.015 mm and 0.035 mm.

13. The system of claim 9 wherein the width ratio is between 40:1 and 120:1.

14. The system of claim 9 wherein the conductive member comprises copper, the predetermined temperature is between 800 degrees Celsius (C) and 900° C., and the predetermined pressure is 100 megapascal (MPa) and 120 MPa.

15. The system of claim 9 wherein the conductive member comprises aluminum, the predetermined temperature is between 150° C. and 250° C., and the predetermined pressure is 20 MPa and 30 MPa.

16. The system of claim 9 wherein each of the carbon nanotubes is between 80 microns and 120 microns and wherein the predetermined orientation is along a longitudinal axis of the conductive member.

17. An electric conductor for a motor of a vehicle, the electric conductor having a conductive skin layer, the electric conductor comprising:
a conductive member having a first width; and
a conductive layer diffusion bonded about the conductive member free of an intermetallic phase between the conductive layer and the conductive member, the conductive layer having carbon nanotubes disposed thereon at a predetermined orientation for conductivity, the conductive layer having a second width to define a width ratio of the first width to the second width of between 4:1 and 200:1, the conductive layer having greater conductivity than the conductive member,
wherein the first width and the second width define one of a rectangular shape and a circular shape.

18. The electric conductor of claim 17 wherein the first width is between 1 mm and 3 mm.

19. The electric conductor of claim 17 wherein the second width is between 0.015 mm and 0.035 mm.

20. The electric conductor of claim 17 wherein the width ratio is between 40:1 and 120:1.
